(19) United States
(12) Patent Application Publication
(10) Pub. No.: US 2022/0383769 A1
(43) Pub. Date: Dec. 1, 2022

(54) SPEECH SYNTHESIZER WITH MULTIMODAL BLENDING

(71) Applicant: Learning Squared, Inc., Sunnyvale, CA (US)

(72) Inventors: Vera Blau-McCandliss, Stanford, CA (US); Debbie Heimowitz, Pleasanton, CA (US)

(21) Appl. No.: 17/755,594

(22) PCT Filed: Oct. 21, 2020
(86) PCT No.: PCT/US2020/056646

§ 371 Date: May 3, 2022

Related U.S. Application Data
(60) Provisional application No. 62/931,940, filed on Nov. 7, 2019.

(51) Int. Cl. G09B 17/00; G09B 5/02; G06F 3/04847

(52) U.S. Cl. CPC G09B 17/006; G09B 5/02; G06F 3/04847

(57) ABSTRACT

A machine presents a graphical user interface that depicts a word that includes a first letter and a second letter. The machine detects a drag speed of a touch input on a touch-sensitive display screen and determines that the drag speed falls into a first range of drag speeds among multiple ranges of drag speeds. Based on the drag speed falling into the first range, the machine selects whether the word is to be pronounced by sequentially playing at least a first audio file and a second audio file, where the first audio file records a first phoneme for the first letter, and the second audio file records a second phoneme for the second letter. Accordingly, the machine provides a speech synthesizer that pronounces the word at a pronunciation speed based on the drag speed, with enhanced clarity at slower speeds, and with enhanced smoothness at higher speeds.

### RELATED APPLICATION

This application claims the priority benefit of U.S. Provisional Patent Application No. 62/931,940, filed Nov. 7, 2019 and titled “SPEECH SYNTHESIZER WITH MULTIMODAL BLENDING,” which is incorporated herein by reference in its entirety.

### TECHNICAL FIELD

The subject matter disclosed herein generally relates to the technical field of special-purpose machines that facilitate speech synthesis, including software-configured computerized variants of such special-purpose machines and improvements to such variants, and to the technologies by which such special-purpose machines become improved compared to other special-purpose machines that facilitate speech synthesis. Specifically, the present disclosure addresses systems and methods to provide a speech synthesizer.

### BACKGROUND

A machine may be configured to interact with one or more users of the machine (e.g., a computer or other device) by presenting an exercise that teaches one or more reading skills to the one or more users or otherwise guides the one or more users through practice of the one or more reading skills. For example, the machine may present an alphabetic letter (e.g., the letter “A” or the letter “B”) within a graphical user interface (GUI), synthesize speech by playing an audio or video recording of an actor pronouncing the presented alphabetic letter, and then prompt a user (e.g., a child who is learning to read) to also pronounce the presented alphabetic letter.

### BRIEF DESCRIPTION OF THE DRAWINGS

Some embodiments are illustrated by way of example and not limitation in the figures of the accompanying drawings.

FIGS. 1-5 are face views of a machine (e.g., a device) with a touch-sensitive display screen on which a GUI suitable for speech synthesis is presented, according to some example embodiments.

FIG. 6 is a block diagram illustrating components of the machine, according to some example embodiments.

FIGS. 7-9 are flowcharts illustrating operations of the machine in performing a method of speech synthesis, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate speech synthesis, and example systems (e.g., special-purpose machines configured by special-purpose software) are configured to facilitate speech synthesis. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A machine (e.g., a mobile device or other computing machine) may be specially configured (e.g., by suitable hardware modules, software modules, or a combination of both) to behave or otherwise function as a speech synthesizer, such as a speech synthesizer with multimodal blending. In accordance with the examples of systems and methods described herein, the machine presents a GUI on a touch-sensitive display screen (e.g., controlled by or otherwise in communication with the mobile device). The GUI depicts a word (e.g., “nap.” “cat,” or “tap”) to be pronounced (e.g., as part of a phonics teaching game or other application). The depicted word includes a sequentially first alphabetic letter (e.g., “n”) and a sequentially second alphabetic letter (e.g., “a”). The machine then detects a drag speed of a touch input on the touch-sensitive display screen and determines that the detected drag speed of the touch input falls into a first range of drag speeds among multiple ranges of drag speeds. Based on (e.g., in response to) the detected drag speed falling into the first range of drag speeds, the machine selects (e.g., chooses or otherwise determines) whether the word is to be pronounced by sequentially playing at least a first audio file and a second audio file, where the first audio file represents a first phoneme that pronounces the sequentially first alphabetic letter of the word, and the second audio file represents a second phoneme that pronounces the sequentially second alphabetic letter of the word.

Each range among the multiple ranges of drag speeds (e.g., a plurality of ranges of drag speeds) may be associated with a corresponding group (e.g., a stored bank) of audio files. The multiple ranges subdivide (e.g., split) the potential drag speeds of the touch input into two or more classifications (e.g., categories or classes), as defined by one or more threshold drag speeds, where each threshold drag speed demarks one or both of two adjacent ranges. For example, if the touch input is detected to have a slow drag speed, the machine identifies a first (e.g., slow speed) group of audio files and obtains one or more audio files from that first group for playing. As another example, if the touch input is detected to have a fast drag speed, the machine identifies a second group (e.g., non-slow speed) group of audio files and obtains an audio file therefrom for playing.

In some example embodiments, three classifications are implemented: slow drag speeds, medium drag speeds, and fast drag speeds, which respectively correspond to three groups of audio files. For example, a first group of audio files for slow drag speeds may contain individual audio files of individual recorded phonemes, spoken at normal speed; a second group of audio files for medium drag speeds may contain audio files of entire recorded words, spoken at slow speed (e.g., with over-pronunciation in articulating each constituent phoneme); and a third group of audio files for fast drag speeds may contain audio files of the same entire recorded words, but spoken at normal speed (e.g., without over-pronunciation) or other speed faster than the slow speed.

The group of audio files selected by the machine may be partially or fully dependent on the drag speed of the touch input. According to the systems and methods discussed herein, one available classification (e.g., category) of the drag speed (e.g., a first range of drag speeds) corresponds to sequential play of individual audio files to pronounce the word, where each of the sequentially played audio files corresponds to an individual phoneme of the word. As noted above, the phonemes recorded in these single-phoneme audio files may be spoken at normal speed. In some example embodiments, an available classification of the drag speed (e.g., a second range of drag speeds) corresponds to play of a single audio file to pronounce the word, where multiple phonemes of the full word are recorded in the single audio file. As noted above, the multiple phonemes of the word recorded in this single audio file may be spoken at slow speed (e.g., slower than normal speed). In certain example embodiments, an available classification of the drag speed (e.g., a third range of drag speeds) corresponds to play of an alternative single audio file to pronounce the word. The multiple phonemes of the full word in this alternative single audio file may be spoken at normal speed instead of at slow speed. In various example embodiments, the multiple phonemes of the word in this or a further alternative single audio file are spoken at fast speed (e.g., faster than normal speed).

In the presented GUI, the first alphabetic letter has a corresponding area (e.g., a first sub-region) configured for detecting the drag speed of the touch input (e.g., based on a first portion thereof that occurs in the corresponding area). The detected drag speed may be applicable to the full word or only a portion thereof that corresponds to the first alphabetic letter. Similarly, the second alphabetic letter may have a corresponding area (e.g., a second sub-region) configured for detecting or updating the drag speed of the touch input (e.g., based on a second portion thereof that occurs in the corresponding area), and the detected or updated drag speed may be applicable to a remainder of the full word or only a portion thereof that corresponds to the second alphabetic letter.

In some example embodiments, the GUI includes a slider bar (e.g., disposed underneath the word or otherwise in visual proximity to the word), and the slider bar moves along a direction in which the word is to be read (e.g., a reading direction of the word, as depicted in the GUI). The movement of the slider bar may be based on the touch input, which may represent movement of a finger of the user. Furthermore, the GUI may include a visual indicator that moves in the direction in which the word is to be read, based on a component (e.g., an input component or other projection component parallel to the reading direction of the word) of the touch input and moves at a speed based on (e.g., proportional to) the drag speed of the touch input. The visual indicator may also move contemporaneously with play of one or more audio files selected by the machine for pronouncing the word.

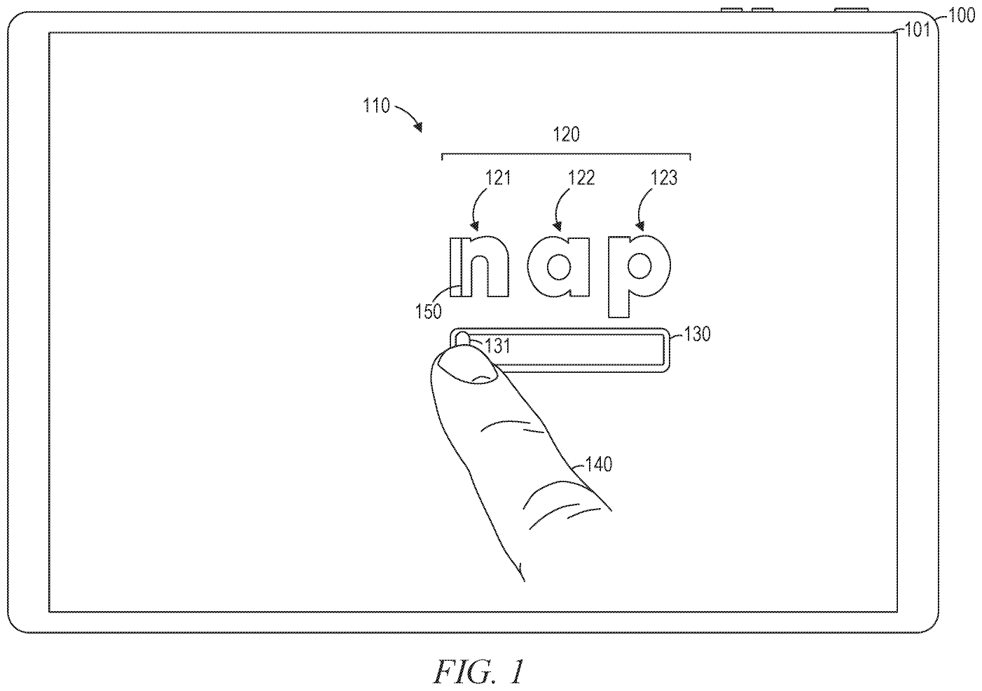

FIGS. 1-5 are face views of a machine 100 (e.g., a device, such as a mobile device) with a display screen 101 on which a GUI 110 suitable for speech synthesis is presented, according to some example embodiments. As shown in FIG. 1, the display screen 101 is touch-sensitive and configured to accept one or more touch inputs from one or more fingers of a user (e.g., a child learning phonics by playing a phonics teaching game), and as an example, a finger 140 is illustrated as touching the display screen 101 of the machine 100.

The GUI 110 is presented on the display screen 101 and depicts (e.g., among other things) a word 120 (e.g., “nap,” as depicted, or alternatively “dog,” “mom,” “dad,” “baby,” “apple.” “school,” or “backpack”) to be pronounced by the machine 100 (e.g., functioning temporarily or permanently as a speech synthesizer), by the user, or both. The GUI 110 is also shown as including a slider control 130 (e.g., a slider bar or other control region of the GUI 110). The slider control 130 may be visually aligned with the word 120. For example, both the slider control 130 and the word 120 may follow the same straight line (e.g., in a direction in which the word 120 is to be read) or follow two parallel lines (e.g., both in the direction in which the word 120 is to be read). As another example, both the slider control 130 and the word 120 may follow the same curved line or follow two curved lines that are a constant distance apart.

As shown in FIG. 1, the slider control 130 may include a slide element 131, such as a position indicator bar or other visual indicator (e.g., a cursor or other marker) that indicates progress in pronouncing the word 120, its constituent letters, its phonemes, or any suitable combination thereof. As further shown in FIG. 1, the word 120 includes one or more alphabetic letters and may therefore include (e.g., among other text characters) a sequentially first alphabetic letter 121 (e.g., “n”) and a sequentially second alphabetic letter 122 (e.g., “a”). The word 120 may further include a third alphabetic letter 123 (e.g., “p”). For example, the word 120 may be a consonant-vowel-consonant (CVC) word, such as “nap” or “cat,” and accordingly include the sequentially first alphabetic letter 121, the sequentially second alphabetic letter 122, and the sequentially third alphabetic letter 123, all ordered and aligned in the direction in which the word 120 is to be read.

Different sub-regions of the slider control 130 may correspond to different alphabetic letters of the word 120 and may be used in detecting or updating a drag speed of a touch input swiping within the slider control 130. Each sub-region of the slider control 130 may be visually aligned with its corresponding alphabetic letter of the word 120. Hence, with reference to FIG. 1, a first sub-region of the slider control 130 may correspond to the sequentially first alphabetic letter 121 (e.g., “n”) and may be visually aligned with the sequentially first alphabetic letter 121, and a second sub-region of the slider control 130 may correspond to the sequentially second alphabetic letter 122 (e.g., “a”) and may be visually aligned with the sequentially second alphabetic letter 122. Similarly, a third sub-region of the slider control 130 may correspond to the sequentially third alphabetic letter 123 (e.g., “p”) and may be visually aligned with the sequentially third alphabetic letter 123.

In addition, the GUI 110 may include a visual indicator 150 of progress in reading the word 120, pronouncing the word 120, or both, and the visual indicator 150 may be or include one or more visual elements that denote an extent to which the word 120 is read or pronounced. As shown in FIGS. 1-5, the visual indicator 150 is a vertical line. However, in various example embodiments, the visual indicator 150 may include a change in color, a change in brightness, a change in fill pattern, a change in size, a change in position (e.g., vertical displacement perpendicular to the direction in which the word 120 is to be read), a visual element (e.g., an arrowhead), or any suitable combination thereof.

As shown in FIG. 1, the finger 140 is performing a touch input (e.g., a swipe gesture or other touch-and-drag input) on the display screen 101. To start the touch input, the finger 140 is touching the display screen 101 at a location within the slider control 130 (e.g., a first location, which may lie within a first sub-region of the slider control 130), and the display screen 101 detects that the finger 140 is touching the display screen 101 at that location. Accordingly, the touch input is beginning (e.g., touching down) within the slider control 130. In response to detection of the finger 140 touching the illustrated location within the GUI 110, the GUI 110 presents the slide element 131 at the same location.

In response to a portion (e.g., a first portion) of the touch input occurring within a first sub-region of the slider control 130, the machine 100 detects a drag speed of the touch input. The first sub-region of the slider control 130 may correspond to the sequentially first alphabetic letter 121 of the word 120. The machine 100 then classifies the detected drag speed and, based thereon, determines what blending mode is to be used for pronouncing the word 120. For example, the machine 100 may select whether the word 120 is to be pronounced by sequentially playing individual audio files, where the audio files store recordings of phonemes that correspond to the sequentially first, second, and third alphabetic letters 121-123 of the word 120, or whether the word 120 is to be pronounced using some alternative blending mode (e.g., by playing a single audio file that stores a recording of the word 120 being spoken in its entirety).

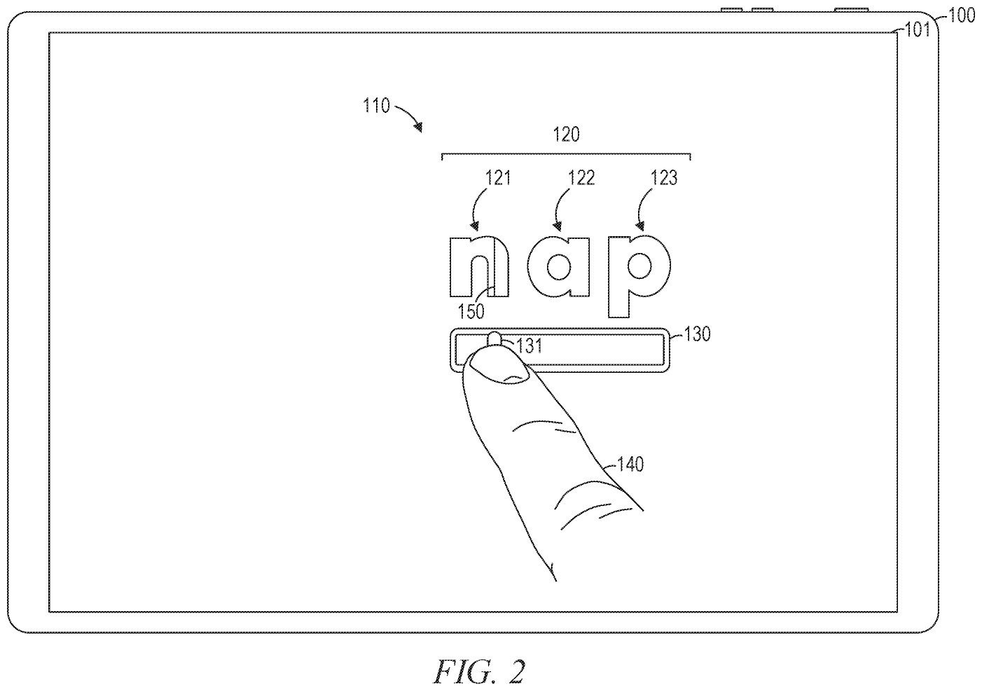

As shown in FIG. 2, the finger 140 continues to perform the touch input on the display screen 101. At the point shown, the finger 140 is touching the display screen 101 at a location (e.g., a second location) within the slider control 130, and the display screen 101 detects that the finger 140 is touching the display screen 101 at that location. Accordingly, the touch input continues its movement within the slider control 130. In response to detection of the finger 140 touching the illustrated location within the GUI 110, the GUI 110 presents the slide element 131 at the same location. As noted above, the slide element 131, the visual indicator 150, or both, may indicate an extent of progress attained in pronouncing the word 120 (e.g., progress up to pronunciation of a phoneme that corresponds to the first sequential alphabetic letter 121, as illustrated in FIG. 2).

According to some example embodiments, in response to a portion (e.g., a second portion) of the touch input occurring within a second sub-region of the slider control 130, the machine 100 detects or updates the drag speed of the touch input. The second sub-region of the slider control 130 may correspond to the sequentially second alphabetic letter 122 of the word 120. The machine 100 may then classify the detected or updated drag speed and, based thereon, determine what blending mode is to be used for pronouncing a remainder of the word 120 (e.g., from the sequentially second alphabetic letter 122 onward, or otherwise without the sequentially first alphabetic letter 121 that corresponds to the first sub-region of the slider control 130). For example, the machine 100 may select whether the remainder of the word 120 is to be pronounced by sequentially playing individual audio files, where the audio files store recordings of phonemes that correspond to the sequentially second and third alphabetic letters 122 and 123 of the word 120, or whether the remainder of the word 120 is to be pronounced using some alternative blending mode (e.g., by playing at least a portion of a single audio file that stores a recording of the word 120 being spoken in its entirety).

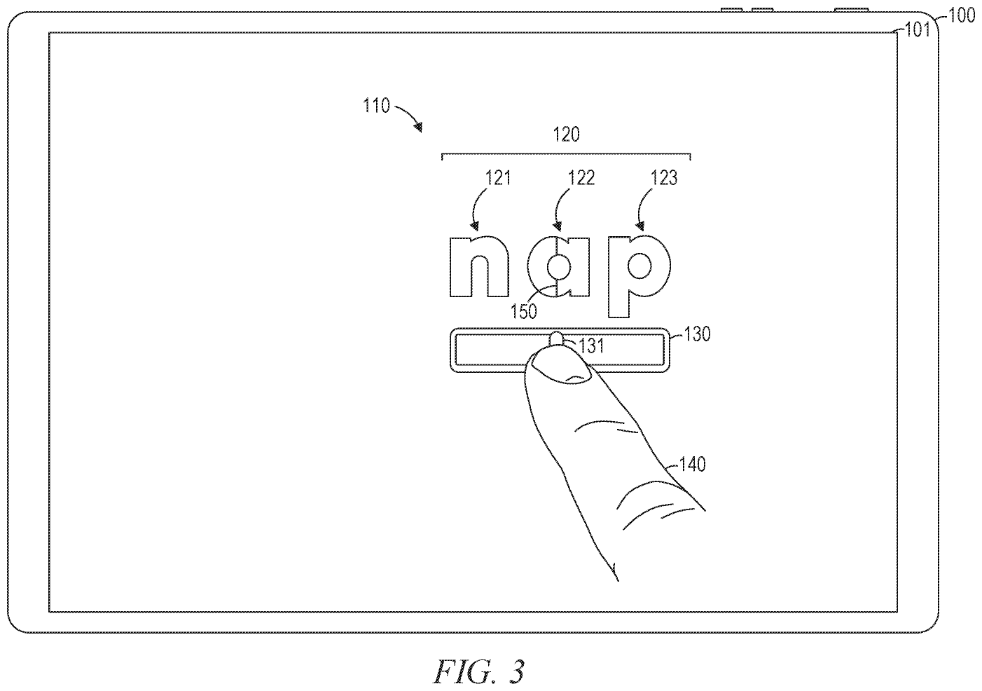

As shown in FIG. 3, the finger 140 continues to perform the touch input on the display screen 101. At the point shown, the finger 140 is touching the display screen 101 at a location (e.g., a third location) within the slider control 130, and the display screen 101 detects that the finger 140 is touching the display screen 101 at that location. Accordingly, the touch input continues its movement within the slider control 130. In response to detection of the finger 140 touching the illustrated location within the GUI 110, the GUI 110 presents the slide element 131 at the same location. As noted above, the slide element 131, the visual indicator 150, or both, may indicate an extent of progress attained in pronouncing the word 120 (e.g., progress up to pronunciation of the phoneme that corresponds to the second sequential alphabetic letter 122, as illustrated in FIG. 3).

According to certain example embodiments, in response to a portion (e.g., a third portion) of the touch input occurring within a third sub-region of the slider control 130, the machine 100 detects or updates the drag speed of the touch input. The third sub-region of the slider control 130 may correspond to the sequentially third alphabetic letter 123 of the word 120. The machine 100 may then classify the detected or updated drag speed and, based thereon, determine what blending mode is to be used for pronouncing a further remainder of the word 120 (e.g., from the sequentially third alphabetic letter 123 onward, or otherwise without the sequentially first and second alphabetic letters 121 and 122 that correspond to the first and second sub-regions of the slider control 130). For example, the machine 100 may select whether the further remainder of the word 120 is to be pronounced by sequentially playing one or more individual audio files, where the one or more audio files store recordings of one or more phonemes that correspond to the sequentially third alphabetic letter 123 (e.g., among further alphabetic letters) of the word 120, or whether the further remainder of the word 120 is to be pronounced using some alternative blending mode (e.g., by playing at least a portion of a single audio file that stores a recording of the word 120 being spoken in its entirety).

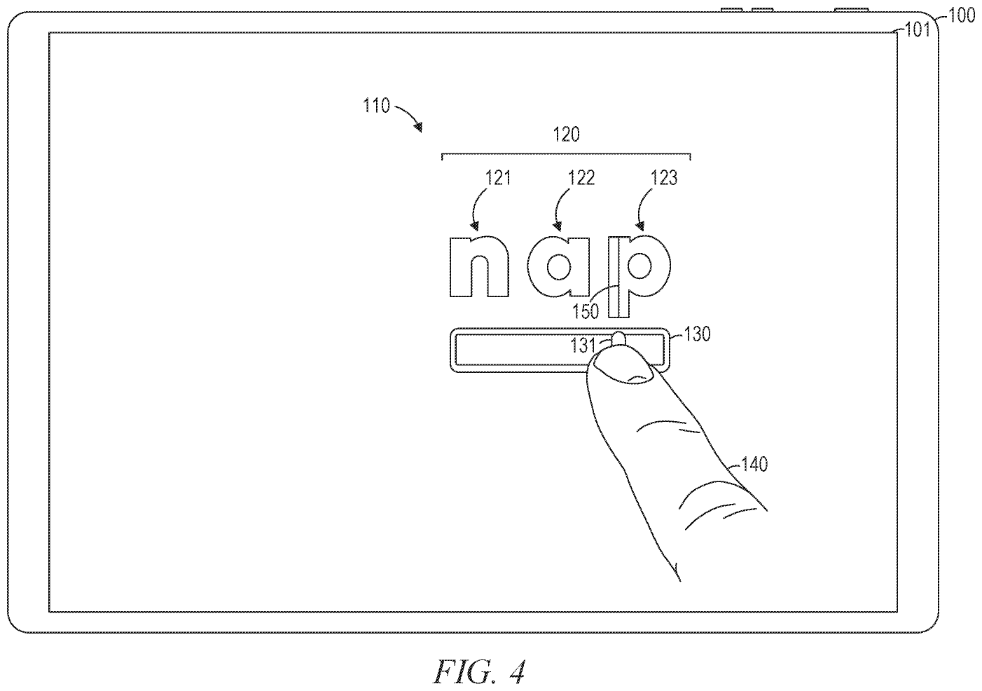

As shown in FIG. 4, the finger 140 continues to perform the touch input on the display screen 101. At the point shown, the finger 140 is touching the display screen 101 at a location (e.g., a fourth location) within the slider control 130, and the display screen 101 detects that the finger 140 is touching the display screen 101 at that location. Accordingly, the touch input continues its movement within the slider control 130. In response to detection of the finger 140 touching the illustrated location within the GUI 110, the GUI 110 presents the slide element 131 at the same location. As noted above, the slide element 131, the visual indicator 150, or both, may indicate an extent of progress attained in pronouncing the word 120 (e.g., progress up to pronunciation of the phoneme that corresponds to the third sequential alphabetic letter 123, as illustrated in FIG. 4).

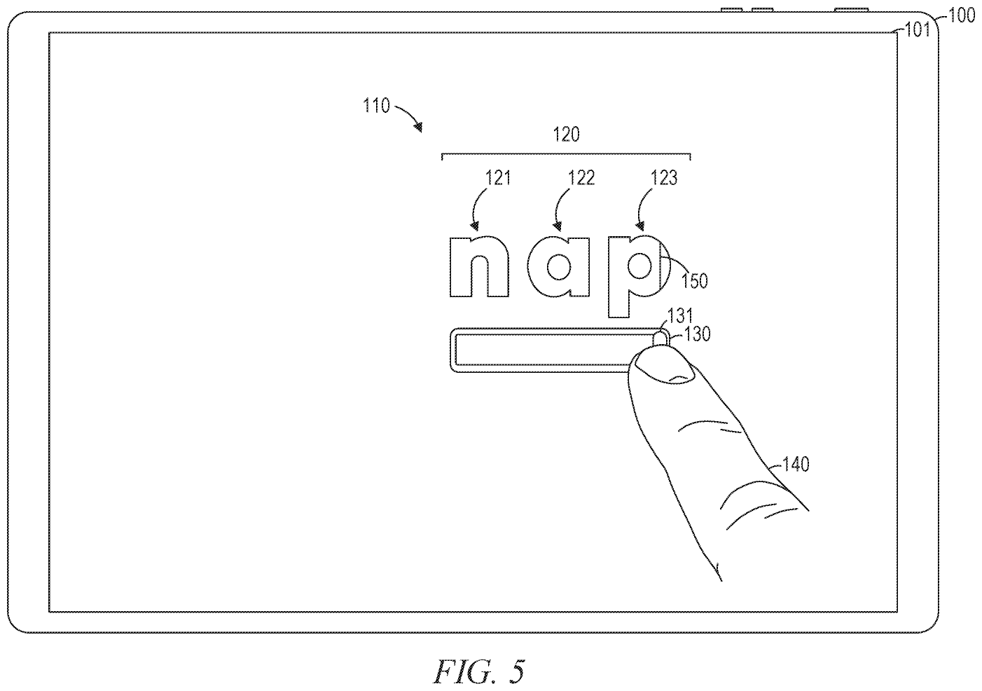

As shown in FIG. 5, the finger 140 is finishing the touch input on the display screen 101 by just lifting off the display screen 101 at a location (e.g., a fifth location) within the slider control 130, and the display screen 101 detects that the finger 140 has moved to this location on the display screen 101 and then stopped contacting the display screen 101. Accordingly, the touch input concludes its movement within the slider control 130. In response to detecting that the finger 140 has lifted off the display screen 101 at the illustrated location within the GUI 110, the GUI 110 presents the slide element 131 at the same location. As noted above, the slide element 131, the visual indicator 150, or both, may indicate an extent of progress attained in pronouncing the word 120 (e.g., progress to completion, as illustrated in FIG. 5).

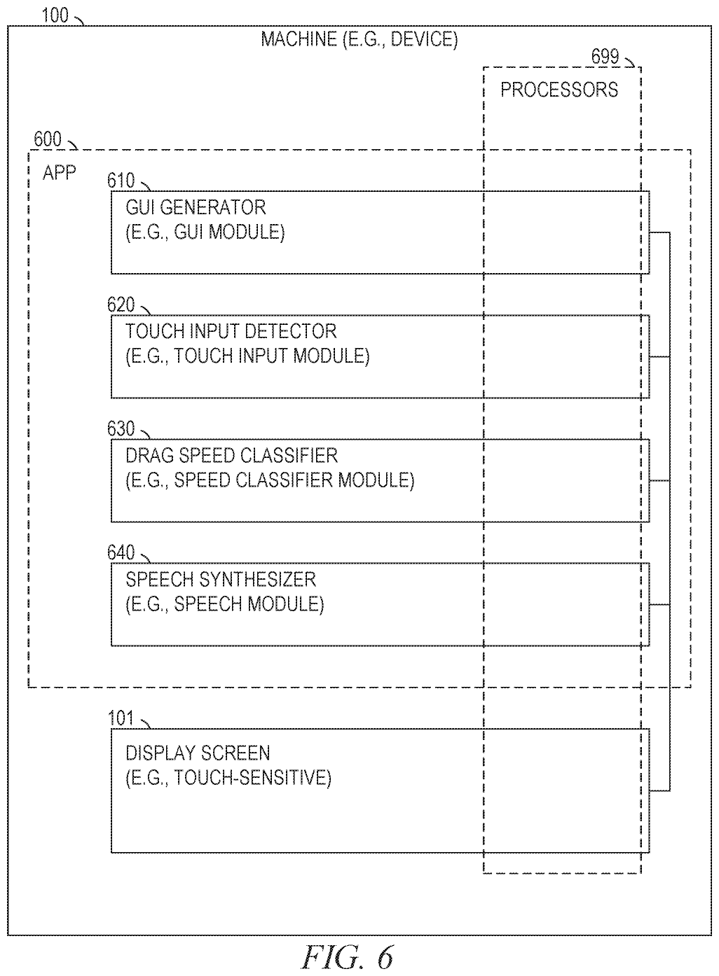

FIG. 6 is a block diagram illustrating components of the machine 100 (e.g., a device, such as a mobile device), according to some example embodiments. The machine 100 is shown as including a GUI generator 610, a touch input detector 620, a drag speed classifier 630, a speech synthesizer 640, and the display screen 101, all configured to communicate with each other (e.g., via a bus, shared memory, or a switch). The GUI generator 610 may be or include a GUI module or similarly suitable software code for generating the GUI 110. The touch input detector 620 may be or include a touch input module or similarly suitable software code for detecting one or more touch inputs (e.g., a touch-and-drag input or a swipe input) occurring on the display screen 101. The drag speed classifier 630 may be or include a speed classifier module or similarly suitable software code for detecting, updating, or otherwise determining the drag speed of a touch input. The speech synthesizer 640 may be or include a speech module or similarly suitable software code for pronouncing the word 120 (e.g., via the machine 100 or any portion thereof, including via the GUI 110, via an audio playback subsystem of the machine 100, or both).

As shown in FIG. 6, the GUI generator 610, the touch input detector 620, the drag speed classifier 630, the speech synthesizer 640, or any suitable combination thereof, may form all or part of an app 600 (e.g., a mobile app) that is stored (e.g., installed) on the machine 100 (e.g., responsive to or otherwise as a result of data being received from one or more server machines via a network). Furthermore, one or more processors 699 (e.g., hardware processors, digital processors, or any suitable combination thereof) may be included (e.g., temporarily or permanently) in the app 600, the GUI generator 610, the touch input detector 620, the drag speed classifier 630, the speech synthesizer 640, or any suitable combination thereof.

Any one or more of the components (e.g., modules) described herein may be implemented using hardware alone (e.g., one or more of the processors 699) or a combination of hardware and software. For example, any component described herein may physically include an arrangement of one or more of the processors 699 (e.g., a subset of or among the processors 699) configured to perform the operations described herein for that component. As another example, any component described herein may include software, hardware, or both, that configure an arrangement of one or more of the processors 699 to perform the operations described herein for that component. Accordingly, different components described herein may include and configure different arrangements of the processors 699 at different points in time or a single arrangement of the processors 699 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

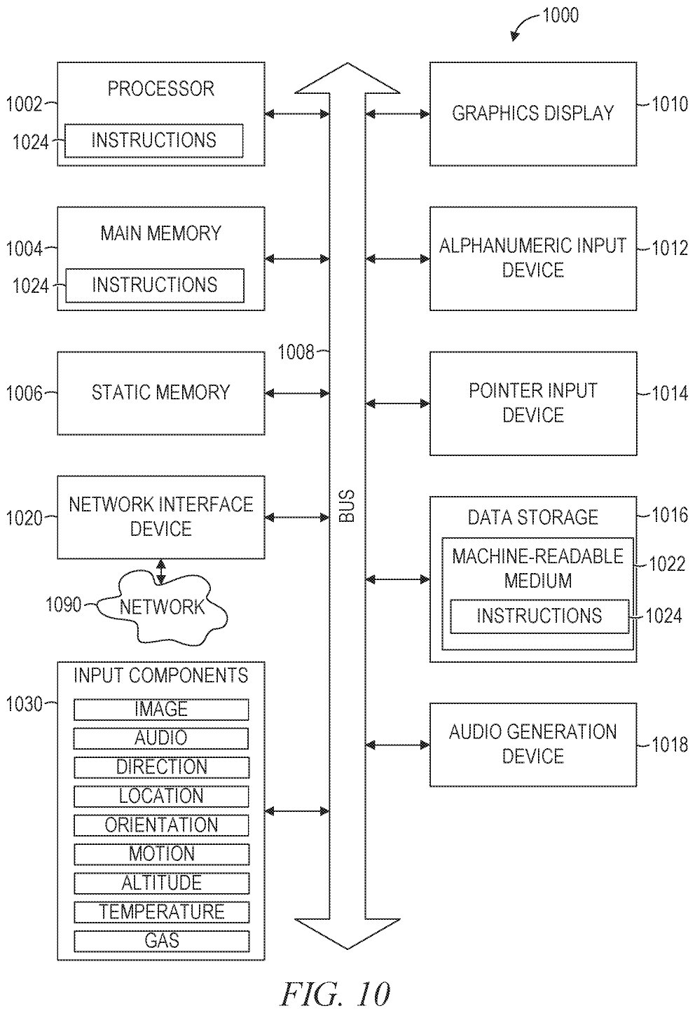

The machine 100 may be, include, or otherwise be implemented in a special-purpose (e.g., specialized or otherwise non-conventional and non-generic) computer that has been modified to perform one or more of the functions described herein (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 10, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Accordingly, the machine 100 may be implemented in the special-purpose (e.g., specialized) computer system, in whole or in part, as described below with respect to FIG. 10. According to various example embodiments, the machine 100 may be or include a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry).

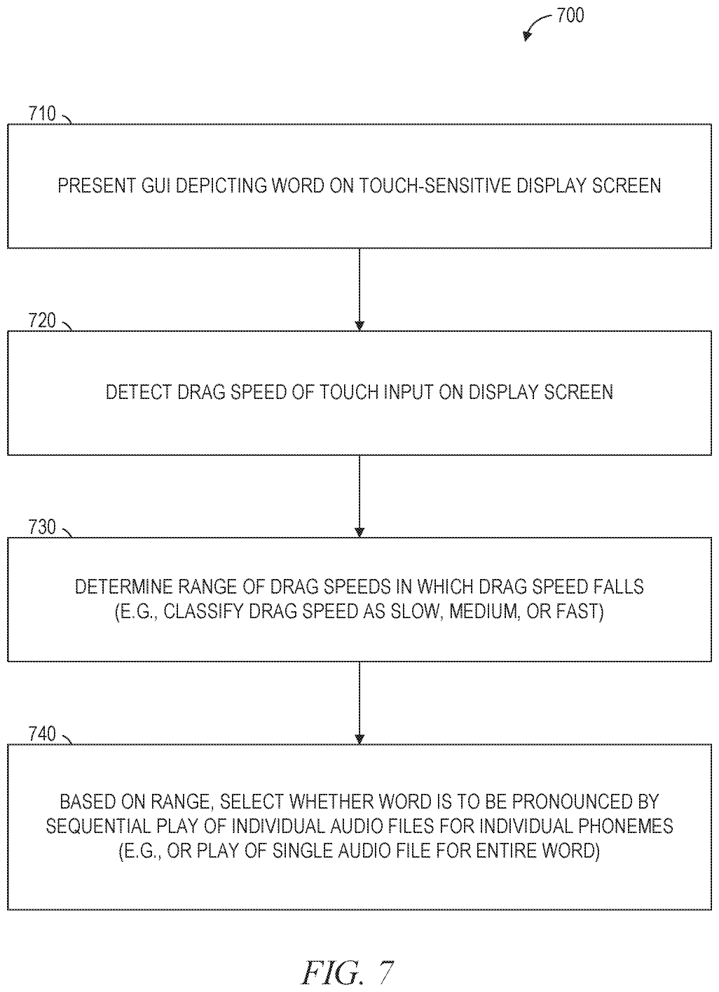

FIGS. 7-9 are flowcharts illustrating operations of the machine 100 in performing a method 700 of speech synthesis, according to some example embodiments. Operations in the method 700 may be performed by the machine 100, using components (e.g., modules) described above with respect to FIG. 6, using one or more processors (e.g., microprocessors or other hardware processors), or using any suitable combination thereof. As shown in FIG. 7, the method 700 includes operations 710, 720, 730, and 740.

In operation 710, the GUI generator 610 generates and presents the GUI 110 on the display screen 101 or otherwise causes the GUI 110 to be presented on the display screen 101. Performance of operation 710 may cause the GUI 110 to appear as illustrated in FIG. 1.

In operation 720, the touch input detector 620 detects (e.g., via, using, in conjunction with, or otherwise based on the display screen 101) a drag speed of a touch input based on at least a portion thereof (e.g., detects a speed at which the touch input is dragging or otherwise moving on the display screen 101). The detection may be performed by measuring the drag speed of the touch input (e.g., in pixels per second, inches per second, or other suitable units of speed). Performance of operation 710 may cause the GUI 110 to appear as illustrated in FIG. 2.

In operation 730, the drag speed classifier 630 determines a range of drag speeds into which the drag speed detected in operation 720 falls. This has the effect of classifying the drag speed into a range (e.g., a first range) of drag speeds among multiple available ranges of drag speeds. For example, the drag speed classifier 630 may determine that the detected drag speed falls into a first range (e.g., for slow drag speeds) among two or more ranges (e.g., for slow drag speeds and for one or more categories of non-slow drag speeds).

In operation 740, based on the range (e.g., the drag speed classification) determined in operation 730, the speech synthesizer 640 selects (e.g., chooses or otherwise determines) whether the word 120 is to be pronounced by sequential play of audio files for individual phonemes (e.g., playing at least a first audio file and a second audio file, where the first audio file represents a first phoneme that pronounces the sequentially first alphabetic letter 121 of the word 120, and where the second audio file represents a second phoneme that pronounces the sequentially second alphabetic letter 122 of the word 120), in contrast with pronouncing the word 120 via an alternative process (e.g., playing a single audio file that represents multiple phonemes of multiple sequential alphabetic letters 121-123 of the word 120 in its entirety).

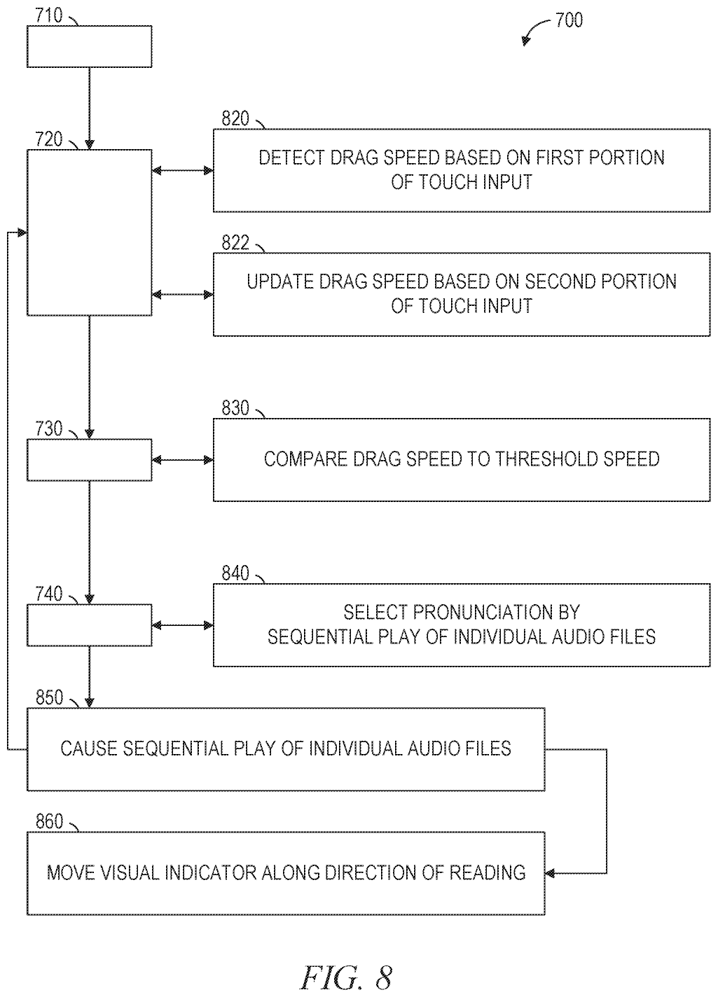

As shown in FIG. 8, in addition to any one or more of the operations previously described, the method 700 may include one or more of operations 820, 822, 830, 840, 850, and 860. Operation 820 may be performed as part (e.g., a precursor task, a subroutine, or a portion) of operation 720, in which the touch input detector 620 detects the drag speed of the touch input. In operation 820, the touch input detector 620 detects the drag speed of the touch input based on a first portion of the touch input. For example, the first portion of the touch input may occur within a first sub-region of the slider control 130, and the touch input detector 620 may detect the drag speed based on the first portion that occurs within the first sub-region. The first sub-region may correspond to the sequentially first alphabetic letter 121 of the word 120, as presented in the GUI 110.

In some example embodiments, the drag speed of the touch input vanes from portion to portion, and accordingly operation 720 may be repeated for additional sub-regions of the slider control 130. In such example embodiments, operation 822 may be performed as part of a repeated instance of operation 720. In operation 822, the touch input detector 620 detects or updates the drag speed of the touch input based on a second portion of the touch input. For example, the second portion of the touch input may occur within a second sub-region of the slider control 130, and the touch input detector 620 may detect the drag speed based on the second portion that occurs within the second sub-region. The second sub-region may correspond to the sequentially second alphabetic letter 122 of the word 120, as presented in the GUI 110.

Operation 830 may be performed as part of operation 730, in which the drag speed classifier 630 determines the range of drag speeds into which the drag speed falls. In operation 830, the drag speed classifier 630 compares the drag speed to one or more threshold speeds (e.g., one or more threshold drag speeds that demark or otherwise define the multiple available ranges of drag speeds). For example, a first threshold drag speed may define an upper limit to a first range that corresponds to a first classification (e.g., slow) of drag speed. Similarly, a second threshold drag speed may define an upper limit to a second range that corresponds to a second classification (e.g., medium or fast), and the second range may be adjacent to the first range.

Operation 840 may be performed as part of operation 740, in which the speech synthesizer 640 selects whether the word 120 is to be pronounced by sequential play of audio files for individual phonemes. This act of selection is made based on (e.g., in response to) the determined range into which the detected drag speed of the touch input falls. One possible outcome is the speech synthesizer 640 selecting that the word 120 is indeed to be pronounced by sequential play of audio files for individual phonemes, and the selection of this process for pronouncing the word 120 is performed in operation 840.

In example embodiments where operation 740 includes operation 840, operation 850 may be performed after operation 740. In operation 850, the speech synthesizer 640 sequentially plays or otherwise causes sequential play of individual audio files for individual phonemes (e.g., one by one) to pronounce the word 120. For example, the speech synthesizer 640 may cause sequential play of at least a first audio file and a second audio file, where the first audio file records a first phoneme that pronounces the sequentially first alphabetic letter 121 of the word 120, and where the second audio file records a second phoneme that pronounces the sequentially second alphabetic letter 122 of the word 120.

In operation 860, the GUI generator 610 moves the visual indicator 150 along a direction in which the word 120 is to be read. The visual indicator 150 may move contemporaneously with the touch input, with the sequential playing of audio files for individual phonemes, with the speech synthesizer 640 pronouncing the word 120, or with any suitable combination thereof.

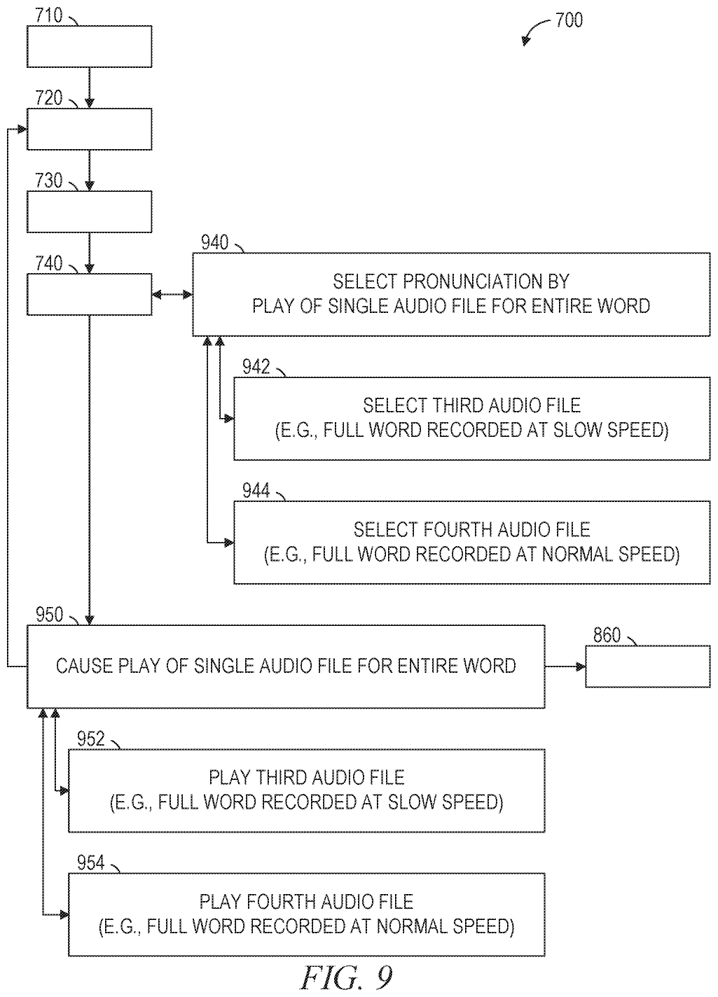

As shown in FIG. 9, in addition to any one or more of the operations previously described, the method 700 may include one or more of operations 940 and 950. In some example embodiments, operation 940 includes operation 942, and operation 950 includes operation 952. In alternative example embodiments, operation 940 includes operation 944, and operation 950 includes operation 954.

Operation 940 may be performed as part of operation 740, in which the speech synthesizer 640 selects whether the word 120 is to be pronounced by sequential play of audio files for individual phonemes. As noted above, this act of selection is made based on (e.g., in response to) the determined range into which the detected drag speed of the touch input falls. One possible outcome is the speech synthesizer 640 selecting that the word 120 is to be pronounced by playing a single audio file that records the multiple phonemes (e.g., all of the phonemes) of the word 120 in its entirety, instead of sequentially playing separate audio files for individual phonemes, and the selection of this alternative process for pronouncing the word 120 is performed in operation 940.

In example embodiments where operation 740 includes operation 940, operation 950 may be performed after operation 740. In operation 950, the speech synthesizer 640 plays or otherwise causes play of such a single audio file to pronounce the word 120.

As noted above, in some example embodiments, operation 940 includes operation 942, and operation 950 includes operation 952. In operation 942, as part of selecting that the word 120 is to be pronounced by playing a single audio file, the speech synthesizer 640 selects a third audio file for playing to pronounce the word 120, where the third audio file represents (e.g., records) the phonemes that correspond to the sequential alphabetic letters 121-123 of the word 120, spoken at a slow speed (e.g., a speaking speed lower than normal speaking speed). In corresponding operation 952, the speech synthesizer 640 plays or causes play of the third audio file selected in operation 942, to pronounce the word 120.

As also noted above, in certain example embodiments, operation 940 includes operation 944, and operation 950 includes operation 954. In operation 944, as part of selecting that the word 120 is to be pronounced by playing a single audio file, the speech synthesizer 640 selects a fourth audio file for playing to pronounce the word 120, where the fourth audio file represents (e.g., records) the phonemes that correspond to the sequential alphabetic letters 121-123 of the word 120, spoken at a normal speed or at a speaking speed faster than the slow speaking speed of the third audio file. In corresponding operation 954, the speech synthesizer 640 plays or causes play of the fourth audio file, selected in operation 944, to pronounce the word 120.

According to various example embodiments, one or more of the methodologies described herein may facilitate provision of a speech synthesizer with multiple modes for blending phonemes together to pronounce a word. Moreover, one or more of the methodologies described herein may facilitate provision of a user-friendly experience in which the drag speed of a touch input fully or partially controls which blending mode is selected by a speech synthesizer. In particular, the drag speed of the touch input is a basis for determining whether individual audio files for individual phonemes are to be played, as opposed to some other process for pronouncing the word. Hence, one or more of the methodologies described herein may facilitate pronunciation of the word at a speed desired by a user, with enhanced clarity at slower speeds, and with enhanced smoothness at higher speeds, as well as provision of at least one visual indicator of progress toward completion of pronouncing the word (e.g., in its direction of reading), compared to capabilities of pre-existing systems and methods.

When these effects are considered in aggregate, one or more of the methodologies described herein may obviate a need for certain efforts or resources that otherwise would be involved in provision of a speech synthesizer. Efforts expended by a user in providing a dynamically adaptive speech synthesizer with multimodal blending may be reduced by use of (e.g., reliance upon) a special-purpose machine that implements one or more of the methodologies described herein. Computing resources used by one or more systems or machines (e.g., within a network environment) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be communicatively coupled (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof), a main memory 1004, and a static memory 1006, which are configured to communicate with each other via a bus 1008. The processor 1002 contains solid-state digital microcircuits (e.g., electronic, optical, or both) that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein. In some example embodiments, the processor 1002 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 1000 with at least the processor 1002, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a pointer input device 1014 (e.g., a mouse, a touchpad, a touchscreen, a trackball, a joystick, a stylus, a motion sensor, an eye tracking device, a data glove, or other pointing instrument), a data storage 1016, an audio generation device 1018 (e.g., a sound card, an amplifier, a speaker, a headphone jack, or any suitable combination thereof), and a network interface device 1020.

The data storage 1016 (e.g., a data storage device) includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the static memory 1006, within the processor 1002 (e.g., within the processor's cache memory), or any suitable combination thereof, before or during execution thereof by the machine 1000. Accordingly, the main memory 1004, the static memory 1006, and the processor 1002 may be considered machine-readable media (e.g., tangible and non-transitory machine-readable media). The instructions 1024 may be transmitted or received over the network 1090 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device (e.g., a smart phone, a tablet computer, or a wearable device) and may have one or more additional input components 1030 (e.g., sensors or gauges). Examples of such input components 1030 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a temperature input component (e.g., a thermometer), and a gas detection component (e.g., a gas sensor). Input data gathered by any one or more of these input components 1030 may be accessible and available for use by any of the modules described herein (e.g., with suitable privacy notifications and protections, such as opt-in consent or opt-out consent, implemented in accordance with user preference, applicable regulations, or any suitable combination thereof).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of carrying (e.g., storing or communicating) the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof.

A “non-transitory” machine-readable medium, as used herein, specifically excludes propagating signals per se. According to various example embodiments, the instructions 1024 for execution by the machine 1000 can be communicated via a carrier medium (e.g., a machine-readable carrier medium). Examples of such a carrier medium include a non-transient carrier medium (e.g., a non-transitory machine-readable storage medium, such as a solid-state memory that is physically movable from one place to another place) and a transient carrier medium (e.g., a carrier wave or other propagating signal that communicates the instructions 1024).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals.” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions describe various examples of methods, machine-readable media, and systems (e.g., machines, devices, or other apparatus) discussed herein.

A first example provides a method comprising:

presenting, by one or more processors of a machine, a graphical user interface (GUI) on a touch-sensitive display screen, the GUI depicting a word to be pronounced, the word including a sequentially first alphabetic letter and a sequentially second alphabetic letter;
detecting, by one or more processors of the machine, a drag speed of a touch input on the touch-sensitive display screen;
determining, by one or more processors of the machine, that the detected drag speed of the touch input falls into a first range of drag speeds among a plurality of ranges of drag speeds; and
selecting, by one or more processors of the machine and based on the detected drag speed falling into the first range of drag speeds, whether the word is to be pronounced by sequentially playing at least a first audio file and a second audio file, the first audio file representing a first phoneme that pronounces the sequentially first alphabetic letter of the word, the second audio file representing a second phoneme that pronounces the sequentially second alphabetic letter of the word.

A second example provides a method according to the first example, wherein:

the selecting of whether the word is to be pronounced by sequentially playing at least the first audio file and the second audio file includes selecting that the word is to be pronounced by sequentially playing at least the first audio file and the second audio file; and
the method further comprises:
causing sequential play of at least the first audio file and the second audio file to pronounce the word.

A third example provides a method according to the first example, wherein:

the selecting of whether the word is to be pronounced by sequentially playing at least the first audio file and the second audio file includes selecting that the word is to be pronounced by playing a third audio file that represents multiple phonemes of the word and without sequentially playing the first audio file and the second audio file; and
the method further comprises:
causing play of the third audio file to pronounce the word without sequentially playing the first audio file and the second audio file.

A fourth example provides a method according to any of the first through third examples, wherein:

the GUI indicates a region configured to receive the touch input, the region including a sub-region configured to detect the drag speed of the touch input based on a portion of the touch input, the portion occurring within the sub-region of the region of the GUI; and
the determining that the detected drag speed falls into the first range of drag speeds is based on the portion of the touch input within the sub-region of the region of the GUI.

A fifth example provides a method according to any of the first through fourth examples, wherein:

a second range of drag speeds among the plurality of ranges of drag speeds is adjacent to the first range of drag speeds; and
the determining that the detected drag speed of the touch input falls into the first range of drag speeds includes comparing the detected drag speed to a threshold drag speed that demarks at least one of the first range of drag speeds or the second range of drag speeds.

A sixth example provides a method according to any of the first through fifth examples, wherein:

the first range of drag speeds among the plurality of ranges of drag speeds corresponds to sequential play of at least the first audio file and the second audio file; and
a second range of drag speeds among the plurality of ranges of drag speeds corresponds to play of a third audio file that represents multiple phonemes of the word.

A seventh example provides a method according to the sixth example, wherein:

the first audio file represents the first phoneme recorded at a first pronunciation speed distinct from a second pronunciation speed at which the word is recorded in the third audio file; and
the second audio file represents the second phoneme recorded at the first pronunciation speed distinct from the second pronunciation speed at which the word is recorded in the third audio file.

An eighth example provides a method according to the seventh example, wherein:

a third range of drag speeds among the plurality of ranges of drag speeds corresponds to play of a fourth audio file that represents the multiple phonemes of the word recorded at the first pronunciation speed distinct from the second pronunciation speed at which the word is recorded in the third audio file.

A ninth example provides a method according to any of the first through eighth examples, wherein:

the word depicted in the GUI has a direction in which the word is to be read; the touch input has an input component parallel to the direction in which the word is to be read; and
the GUI includes a visual indicator that moves in the direction in which the word is to be read based on the input component of the touch input.

A tenth example provides a method according to any of the first through ninth examples, wherein:

the GUI indicates a region configured to receive the touch input, the region including a first sub-region configured to detect the drag speed of the touch input based on a first portion of the touch input, the first portion occurring within the first sub-region and corresponding to the sequentially first alphabetic letter of the word, the region further including a second sub-region configured to update the drag speed of the touch input based on a second portion of the touch input, the second portion occurring within the second sub-region and corresponding to the sequentially second alphabetic letter of the word;
the selecting of whether the word is to be pronounced by sequentially playing at least the first audio file and the second audio file is based on the detected drag speed of the first portion of the touch input; and
the method further comprises:
based on the updated drag speed of the second portion of the touch input, selecting whether a remainder of the word is to be pronounced by sequentially playing at least the second audio file.

An eleventh example provides a machine-readable medium (e.g., a non-transitory machine-readable storage medium) comprising instructions that, when executed by one or more processors of a machine, cause the machine to perform operations comprising:

presenting a graphical user interface (GUI) on a touch-sensitive display screen, the GUI depicting a word to be pronounced, the word including a sequentially first alphabetic letter and a sequentially second alphabetic letter;
detecting a drag speed of a touch input on the touch-sensitive display screen;
determining that the detected drag speed of the touch input falls into a first range of drag speeds among a plurality of ranges of drag speeds; and
based on the detected drag speed falling into the first range of drag speeds, selecting whether the word is to be pronounced by sequentially playing at least a first audio file and a second audio file, the first audio file representing a first phoneme that pronounces the sequentially first alphabetic letter of the word, the second audio file representing a second phoneme that pronounces the sequentially second alphabetic letter of the word.

A twelfth example provides a machine-readable medium according to the eleventh example, wherein:

the selecting of whether the word is to be pronounced by sequentially playing at least the first audio file and the second audio file includes selecting that the word is to be pronounced by sequentially playing at least the first audio file and the second audio file; and
the operations further comprise:
causing sequential play of at least the first audio file and the second audio file to pronounce the word.

A thirteenth example provides a machine-readable medium according to the eleventh example, wherein:

the selecting of whether the word is to be pronounced by sequentially playing at least the first audio file and the second audio file includes selecting that the word is to be pronounced by playing a third audio file that represents multiple phonemes of the word and without sequentially playing the first audio file and the second audio file; and
the operations further comprise:
causing play of the third audio file to pronounce the word without sequentially playing the first audio file and the second audio file.

A fourteenth example provides a machine-readable medium according to any of the eleventh through thirteenth examples, wherein:

the first range of drag speeds among the plurality of ranges of drag speeds corresponds to sequential play of at least the first audio file and the second audio file; and
a second range of drag speeds among the plurality of ranges of drag speeds corresponds to play of a third audio file that represents multiple phonemes of the word.

A fifteenth example provides a machine-readable medium according to the fourteenth example, wherein:

a third range of drag speeds among the plurality of ranges of drag speeds corresponds to play of a fourth audio file that represents the multiple phonemes of the word recorded at a first pronunciation speed distinct from a second pronunciation speed at which the word is recorded in the third audio file.

A sixteenth example provides a system (e.g., a computer system) comprising:

one or more processors; and
a memory storing instructions that, when executed by at least one processor among the one or more processors, cause the system to perform operations comprising:
presenting a graphical user interface (GUI) on a touch-sensitive display screen, the GUI depicting a word to be pronounced, the word including a sequentially first alphabetic letter and a sequentially second alphabetic letter;
detecting a drag speed of a touch input on the touch-sensitive display screen;
determining that the detected drag speed of the touch input falls into a first range of drag speeds among a plurality of ranges of drag speeds; and
based on the detected drag speed falling into the first range of drag speeds, selecting whether the word is to be pronounced by sequentially playing at least a first audio file and a second audio file, the first audio file representing a first phoneme that pronounces the sequentially first alphabetic letter of the word, the second audio file representing a second phoneme that pronounces the sequentially second alphabetic letter of the word.

A seventeenth example provides a system according to the sixteenth example, wherein:

the selecting of whether the word is to be pronounced by sequentially playing at least the first audio file and the second audio file includes selecting that the word is to be pronounced by sequentially playing at least the first audio file and the second audio file; and
the operations further comprise:
causing sequential play of at least the first audio file and the second audio file to pronounce the word.

An eighteenth example provides a system according to the sixteenth example, wherein:

the selecting of whether the word is to be pronounced by sequentially playing at least the first audio file and the second audio file includes selecting that the word is to be pronounced by playing a third audio file that represents multiple phonemes of the word and without sequentially playing the first audio file and the second audio file; and
the operations further comprise:
causing play of the third audio file to pronounce the word without sequentially playing the first audio file and the second audio file.

A nineteenth example provides a system according to any of the sixteenth through eighteenth examples, wherein:

the first range of drag speeds among the plurality of ranges of drag speeds corresponds to sequential play of at least the first audio file and the second audio file; and
a second range of drag speeds among the plurality of ranges of drag speeds corresponds to play of a third audio file that represents multiple phonemes of the word.

A twentieth example provides a system according to the nineteenth example, wherein:

the first audio file represents the first phoneme recorded at a first pronunciation speed distinct from a second pronunciation speed at which the word is recorded in the third audio file; and
the second audio file represents the second phoneme recorded at the first pronunciation speed distinct from the second pronunciation speed at which the word is recorded in the third audio file.

A twenty-first example provides a carrier medium carrying machine-readable instructions for controlling a machine to carry out the operations (e.g., method operations) performed in any one of the previously described examples.

What is claimed is:

1. A method comprising:
presenting, by one or more processors of a machine, a graphical user interface (GUI) on a touch-sensitive display screen, the GUI depicting a word to be pronounced, the word including a sequentially first alphabetic letter and a sequentially second alphabetic letter;
detecting, by one or more processors of the machine, a drag speed of a touch input on the touch-sensitive display screen;
determining, by one or more processors of the machine, that the detected drag speed of the touch input falls into a first range of drag speeds among a plurality of ranges of drag speeds; and
selecting, by one or more processors of the machine and based on the detected drag speed falling into the first range of drag speeds, whether the word is to be pronounced by sequentially playing at least a first audio file and a second audio file, the first audio file representing a first phoneme that pronounces the sequentially first alphabetic letter of the word, the second audio file representing a second phoneme that pronounces the sequentially second alphabetic letter of the word.

2. The method of claim 1, wherein:
the selecting of whether the word is to be pronounced by sequentially playing at least the first audio file and the second audio file includes selecting that the word is to be pronounced by sequentially playing at least the first audio file and the second audio file; and
the method further comprises:
causing sequential play of at least the first audio file and the second audio file to pronounce the word.

3. The method of claim 1, wherein:
the selecting of whether the word is to be pronounced by sequentially playing at least the first audio file and the second audio file includes selecting that the word is to be pronounced by playing a third audio file that represents multiple phonemes of the word and without sequentially playing the first audio file and the second audio file; and
the method further comprises:
causing play of the third audio file to pronounce the word without sequentially playing the first audio file and the second audio file.

4. The method of claim 1, wherein:
the GUI indicates a region configured to receive the touch input, the region including a sub-region configured to detect the drag speed of the touch input based on a portion of the touch input, the portion occurring within the sub-region of the region of the GUI; and
the determining that the detected drag speed falls into the first range of drag speeds is based on the portion of the touch input within the sub-region of the region of the GUI.

5. The method of claim 1, wherein:
a second range of drag speeds among the plurality of ranges of drag speeds is adjacent to the first range of drag speeds; and
the determining that the detected drag speed of the touch input falls into the first range of drag speeds includes comparing the detected drag speed to a threshold drag speed that demarks at least one of the first range of drag speeds or the second range of drag speeds.

6. The method of claim 1, wherein:
the first range of drag speeds among the plurality of ranges of drag speeds corresponds to sequential play of at least the first audio file and the second audio file; and
a second range of drag speeds among the plurality of ranges of drag speeds corresponds to play of a third audio file that represents multiple phonemes of the word.

7. The method of claim 6, wherein:
the first audio file represents the first phoneme recorded at a first pronunciation speed distinct from a second pronunciation speed at which the word is recorded in the third audio file; and
the second audio file represents the second phoneme recorded at the first pronunciation speed distinct from the second pronunciation speed at which the word is recorded in the third audio file.

8. The method of claim 7, wherein:
a third range of drag speeds among the plurality of ranges of drag speeds corresponds to play of a fourth audio file that represents the multiple phonemes of the word recorded at the first pronunciation speed distinct from the second pronunciation speed at which the word is recorded in the third audio file.

9. The method of claim 1, wherein:
the word depicted in the GUI has a direction in which the word is to be read;
the touch input has an input component parallel to the direction in which the word is to be read; and
the GUI includes a visual indicator that moves in the direction in which the word is to be read based on the input component of the touch input.

10. The method of claim 1, wherein:
the GUI indicates a region configured to receive the touch input, the region including a first sub-region configured to detect the drag speed of the touch input based on a first portion of the touch input, the first portion occurring within the first sub-region and corresponding to the sequentially first alphabetic letter of the word, the region further including a second sub-region configured to update the drag speed of the touch input based on a second portion of the touch input, the second portion occurring within the second sub-region and corresponding to the sequentially second alphabetic letter of the word;
the selecting of whether the word is to be pronounced by sequentially playing at least the first audio file and the second audio file is based on the detected drag speed of the first portion of the touch input; and
the method further comprises:
based on the updated drag speed of the second portion of the touch input, selecting whether a remainder of the word is to be pronounced by sequentially playing at least the second audio file.

11. A machine-readable medium comprising instructions that, when executed by one or more processors of a machine, cause the machine to perform operations comprising:
presenting a graphical user interface (GUI) on a touch-sensitive display screen, the GUI depicting a word to be pronounced, the word including a sequentially first alphabetic letter and a sequentially second alphabetic letter;
detecting a drag speed of a touch input on the touch-sensitive display screen;
determining that the detected drag speed of the touch input falls into a first range of drag speeds among a plurality of ranges of drag speeds; and
based on the detected drag speed falling into the first range of drag speeds, selecting whether the word is to be pronounced by sequentially playing at least a first audio file and a second audio file, the first audio file representing a first phoneme that pronounces the sequentially first alphabetic letter of the word, the second audio file representing a second phoneme that pronounces the sequentially second alphabetic letter of the word.

12. The machine-readable medium of claim 11, wherein:
the selecting of whether the word is to be pronounced by sequentially playing at least the first audio file and the second audio file includes selecting that the word is to be pronounced by sequentially playing at least the first audio file and the second audio file; and
the operations further comprise:
causing sequential play of at least the first audio file and the second audio file to pronounce the word.

13. The machine-readable medium of claim 11, wherein:
the selecting of whether the word is to be pronounced by sequentially playing at least the first audio file and the second audio file includes selecting that the word is to be pronounced by playing a third audio file that represents multiple phonemes of the word and without sequentially playing the first audio file and the second audio file; and
the operations further comprise:
causing play of the third audio file to pronounce the word without sequentially playing the first audio file and the second audio file.

14. The machine-readable medium of claim 11, wherein:
the first range of drag speeds among the plurality of ranges of drag speeds corresponds to sequential play of at least the first audio file and the second audio file; and
a second range of drag speeds among the plurality of ranges of drag speeds corresponds to play of a third audio file that represents multiple phonemes of the word.

15. The machine-readable medium of claim 14, wherein:
a third range of drag speeds among the plurality of ranges of drag speeds corresponds to play of a fourth audio file that represents the multiple phonemes of the word recorded at a first pronunciation speed distinct from a second pronunciation speed at which the word is recorded in the third audio file.

16. A system comprising:
one or more processors; and
a memory storing instructions that, when executed by at least one processor among the one or more processors, cause the system to perform operations comprising:
presenting a graphical user interface (GUI) on a touch-sensitive display screen, the GUI depicting a word to be pronounced, the word including a sequentially first alphabetic letter and a sequentially second alphabetic letter;
detecting a drag speed of a touch input on the touch-sensitive display screen:
determining that the detected drag speed of the touch input falls into a first range of drag speeds among a plurality of ranges of drag speeds; and
based on the detected drag speed falling into the first range of drag speeds, selecting whether the word is to be pronounced by sequentially playing at least a first audio file and a second audio file, the first audio file representing a first phoneme that pronounces the sequentially first alphabetic letter of the word, the second audio file representing a second phoneme that pronounces the sequentially second alphabetic letter of the word.

17. The system of claim 16, wherein:
the selecting of whether the word is to be pronounced by sequentially playing at least the first audio file and the second audio file includes selecting that the word is to be pronounced by sequentially playing at least the first audio file and the second audio file; and
the operations further comprise:
causing sequential play of at least the first audio file and the second audio file to pronounce the word.

18. The system of claim 16, wherein:
the selecting of whether the word is to be pronounced by sequentially playing at least the first audio file and the second audio file includes selecting that the word is to be pronounced by playing a third audio file that represents multiple phonemes of the word and without sequentially playing the first audio file and the second audio file; and
the operations further comprise:
causing play of the third audio file to pronounce the word without sequentially playing the first audio file and the second audio file.

19. The system of claim 16, wherein:
the first range of drag speeds among the plurality of ranges of drag speeds corresponds to sequential play of at least the first audio file and the second audio file; and
a second range of drag speeds among the plurality of ranges of drag speeds corresponds to play of a third audio file that represents multiple phonemes of the word.

20. The system of claim 19, wherein:
the first audio file represents the first phoneme recorded at a first pronunciation speed distinct from a second pronunciation speed at which the word is recorded in the third audio file; and
the second audio file represents the second phoneme recorded at the first pronunciation speed distinct from the second pronunciation speed at which the word is recorded in the third audio file.
